(19) United States
(12) Patent Application Publication
(10) Pub. No.: US 2025/0178277 A1
(43) Pub. Date: Jun. 5, 2025

(54) HEAT TREATMENT OF 3D PRINTED PARTS

(71) Applicant: CYTIVA SWEDEN AB, Uppsala (SE)

(72) Inventors: Johan Alriksson, Uppsala (SE); Stefan Dargy, Uppsala (SE); Mikael Winestrom, Uppsala (SE)

(21) Appl. No.: 18/839,118

(22) PCT Filed: Feb. 15, 2023
(86) PCT No.: PCT/EP2023/053794

§ 371 Date: Aug. 16, 2024

(30) Foreign Application Priority Data
Feb. 21, 2022 (GB) 2202302.2

(51) Int. Cl. B29C 64/30; B29C 64/393; B29C 71/02; B29K 23/00; B29L 31/00; B33Y 40/20; B33Y 50/02; B33Y 80/00

(52) U.S. Cl. CPC B29C 64/30; B29C 64/393; B29C 71/02; B33Y 40/20; B33Y 50/02; B33Y 80/00; B29K 2023/12; B29K 2905/00; B29K 2995/0073; B29L 2031/7278

(57) ABSTRACT

The present invention relates to a device (100) for surface treatment of 3D printed parts for bioprocessing equipment. The device (100) comprises a resurfacing tool (110) comprising a contact surface (116), wherein the contact surface (116) comprises a negative shape of a surface to be treated of a 3D printed part. The device (100) also comprises a heating device (120) operable to heat the resurfacing tool (110) to a temperature above the melting temperature of a material of the 3D printed part. The device (100) also comprises an actuator (130) operable to move the resurfacing tool (110) such that the resurfacing tool (110) can be releasably pressed against the surface to be treated to melt said surface to form a molten layer of said material at said surface. The device (100) further comprises a cooling device operable to cool the resurfacing tool (110) to thereby re-solidify the molten layer of said material at said surface to form a treated surface.

### TECHNICAL FIELD

The present invention relates generally to post-processing of 3D printed parts for bioprocessing equipment. More particularly, the present invention relates to a device and a method for surface treatment of a 3D printed part using heat, to improve the surface finish of said 3D printed part.

### BACKGROUND

3D printing technology also referred to as additive manufacturing has been in existence since the 1980's when it was primarily used for rapid prototyping for product development within certain industries. However, it is only in the last decade or so that the true potential of this technology has been realized. At present, 3D printing technology is being used in different technical fields for manufacturing a multitude of objects, ranging from household items, toys, clothes, tools, mechanical and industrial components, human tissues and many more.

3D printing technology offers increased design freedom and allows higher dimensional control over conventional manufacturing techniques like injection moulding and die casting, making it possible to manufacture highly complex structures with accuracy and repeatability.

Two widely used 3D printing technologies are fused deposition modelling (FDM) and selective laser sintering (SLS). In FDM technology, a thermoplastic filament is heated to its melting point and then extruded, layer by layer on a build platform to create a three-dimensional object. SLS on the other hand is a powder-based manufacturing technique where a laser beam is used to selectively mould the particles of a thermoplastic polymer powder placed on a powder bed, causing them to fuse together and build a part layer-by-layer.

One problem commonly associated with most 3D printed objects is that they usually have rough surfaces and thus need some form of post-processing to achieve the required surface finish. Objects printed using the FDM technology typically show prominent stair-stepping effect where layer marks are distinctly visible. One solution to overcome this problem is to reduce the layer heights, but this significantly increases the build time. Longer printing times can cause warping and filament jams. Similarly, objects printed using the SLS technology suffer from the problem of partially melted powder particles sticking to the surface, thus making the surface grainy.

The problem of poor surface finish of 3D printed parts has made the adoption of 3D printing technology difficult particularly in the manufacturing of parts for bioprocessing equipment. Poor surface finish is especially problematic if said bioprocessing equipment parts are joining parts or intended for use with wetted components where they need to provide adequate sealing function as well. Such parts include but are not limited to, for example, connectors, valves and adaptors that are used to interconnect various components like chromatography columns, filtration units, dispensing units and tubing in a bioprocessing system.

Some of the known post-processing methods include tumbling, water-jetting, sanding, chemical soak and rinse, coating, polishing and bead blasting. The amount of post-processing required depends on several factors including but not limited to the size of the part, the intended application and the type of 3D printing technology used for production.

Some methods of post-processing involve the application of heat, such as ironing, heated isostatic pressing (HIP) and hot gunning. Ironing involves depositing a thin layer of a thermoplastic polymer filament on the surface to be smoothened. However, this process is quite time-consuming and thus adds significantly to the overall build time without resulting in a very good surface finish. Using a hot gun or a flame torch to melt the rough surface is another known heat based post-processing method that is typically used by amateurs and hobbyists. However, this method produces highly uneven melting at the surface being treated resulting in shape distortion or melting away of thin and delicate sections if the operator is not careful enough. Also, as this method uses naked flame, it presents serious safety concerns.

The above-mentioned post-processing methods although considered satisfactory in some applications, are unable to provide the desired degree of surface finish to 3D printed parts used in bioprocessing equipment. The inadequate surface finish achieved using one or more of the above methods may result in surfaces which are not suitable as sealing surfaces in a bioprocessing system thereby making said system prone to leakage. Fluid leakages are highly undesirable in a bioprocessing facility as not only does it lead to loss of valuable biological products such as antibodies and other cell therapy products but could also cause contamination of the surrounding environment in case the biological product is a virus containing solution or the like.

Another problem that may arise is sticking where due to the friction between poorly finished surfaces of said parts, increased joining/releasing forces are required to connect/disconnect said parts with other parts in a bioprocessing system. Use of increased forces can also cause turbulence which could be damaging to sensitive cell-based products being handled in said system as well to the surrounding bioprocessing equipment.

There, is thus a need for a device and a method for providing superior surface finish to 3D printed parts to make them suitable for bioprocessing equipment.

Hence the present invention, as defined by the appended claims, is provided.

### SUMMARY OF INVENTION

Various aspects and embodiments of the present invention are defined by the appended claims.

In accordance with a first aspect, the present invention provides a device for surface treatment of 3D printed parts for bioprocessing equipment, for example, a chromatography system, a filtration system or an aseptic filling system, whereby a high surface finish is achieved on a treated surface.

The device comprises a resurfacing tool comprising a contact surface wherein the contact surface comprises a negative shape of a surface to be treated of a 3D printed part. In an embodiment of the invention, the resurfacing tool comprises one or more internal fluid channels.

The device also comprises a heating device operable to heat the resurfacing tool to a temperature above the melting temperature of a material of the 3D printed part. In an embodiment of the invention, the heating device comprises an external heated metal block. In another embodiment of the invention, the heating device comprises a heating element integral to the resurfacing tool.

The device further comprises an actuator operable to move the resurfacing tool such that the resurfacing tool can be releasably pressed against the surface to be treated to melt the material of the 3D printed part to form a molten layer of said material at said surface.

The device also comprises a cooling device operable to cool the resurfacing tool to thereby actively re-solidify the molten layer at the surface to be treated to form a treated surface. This may also be used to cool the resurfacing tool before removing it (for example when plastic material of a 3D printed part is cool enough such that it is does not stick to the resurfacing tool and maintains its new surface shape). In one or more embodiments of the invention, the cooling device comprises a coolant fluid source connected to the resurfacing tool.

In one or more embodiments of the invention, the device further comprises a plurality of sensors configured to measure at least one process parameter of a surface treatment method being implemented in the device and a control unit configured to control the surface treatment method based on one or more measurements taken by one or more of the plurality of sensors.

In accordance with a second aspect, the present invention provides a method for surface treatment of 3D printed parts for bioprocessing equipment. In an embodiment of the invention, the method for surface treatment is implemented using a device in accordance with the first aspect of the present invention.

The process comprises heating a resurfacing tool to a temperature above the melting temperature of a material of a 3D printed part provided for surface treatment and pressing the resurfacing tool against a surface to be treated of the 3D printed part for melting said surface to form a molten layer of said material at said surface.

The process further comprises stopping the heating of the resurfacing tool to stop said melting and cooling the resurfacing tool for re-solidifying the molten layer at said surface thereby producing a treated surface. In an embodiment of the invention, the cooling step comprises flowing a coolant fluid through one or more internal fluid channels of the resurfacing tool. As the resurfacing tool gets cooled while being pressed against the surface to be treated, the surface finish of a contact surface of the resurfacing tool gets transferred to the surface to be treated as the molten layer re-solidifies. This is followed by releasing the resurfacing tool from the treated surface.

In accordance with a third aspect, the present invention provides a 3D printed part made of thermoplastics material and wherein said part may comprise at least a part of a surface having a relatively low value mean surface roughness value Ra. For example, a part of such a surface may have a mean Ra that is: less than about 16 μm; less than about 15, 14, 13, 12, 11, 10, 9, 8, 7, 6, 5, 4, 3, 2.4, 2, 1.6, 1.5 or 1 μm; about 0.5 μm; from about 0.4, 0.5 or 0.6 μm to about 0.7, 0.8 or 0.9 μm; from about 0.7 to about 0.8 or 0.9 μm; and/or in the range from about 0.1, 0.2, 0.3, 0.4, 0.5, 0.6, 0.7, 0.8 or 0.9 μm to about 15, 14, 13, 12, 11, 10, 9, 8, 7, 6, 5, 4, 3, 2.4, 2, 1.6, 1.5 or 1 μm.

The 3D printed part could be, for example, a 3D printed valve whose valve seat surface has a Ra value in a low value range of about 0.7-0.9 μm, etc., for example. The resurfacing tool may thus be configured to engage a valve seat portion of a 3D printed part. For example, the resurfacing tool may be of an elongated (e.g. substantially cylindrical) form with a chamfered annular symmetrical sloping surface provided at one end thereof that engages the valve seat portion of a 3D printed part. Surface treatment of such 3D printed parts, particularly at any valve seat portions thereof, is advantageous as it allows for a reduction of any closing forces needed in a valve in order to provide adequate sealing and also reduces the chances of a valve sticking as any such closing forces are released.

In another example, the 3D printed part could be a connector/adaptor whose connecting portions have a surface with Ra value in a low or relatively low value range. For example, 3D printed parts can be provided having lower values than those that are typical of the prior art (e.g. less than about the 16 to 20 μm values for Ra that are currently typical for untreated printed surfaces).

One advantage of the invention is that the surface roughness of a 3D printed part can be significantly reduced in a repeatable manner at one or more locations.

Another advantage of the invention is that 3D printed parts such as connectors and valves can be made without compromising on their sealing capability thus making them suitable for bioprocessing equipment in aseptic environments where sealing is essential and critical.

Another advantage of the invention is that the 3D printed parts processed using the device and method of the invention are highly suitable for use with wetted components in a bioprocessing facility due to their superior sealing surfaces which make them leak resistant.

Another advantage of the invention is that the 3D printed parts can be connected and disconnected without exerting too much force and thus are highly suitable where delicate biologics like therapeutic cells are being handled and turbulence can be problematic.

Yet another advantage of the invention is that, as the resurfacing tool comprises a contact surface comprising a negative shape of the surface to be treated, it ensures a uniform transfer of heat to the surface to be treated by establishing a uniform surface contact and thus resulting in uniform surface finish.

Further benefits and advantages of aspects and embodiments of the present invention will also be apparent to the skilled person when reading the disclosure provided herein.

### BRIEF DESCRIPTION OF DRAWINGS

Various aspects and embodiments of the present invention are described in more detail below with reference to the appended drawings, in which:

FIG. 1 shows a cross-sectional view of a device in accordance with a first embodiment of the present invention.

FIG. 2A shows a perspective view of a resurfacing tool of the device shown in FIG. 1.

FIG. 2B shows a cross-sectional view of the resurfacing tool of the device shown in FIG. 1.

FIG. 3 shows a perspective view of the device shown in FIG. 1.

FIG. 4 shows a cross-sectional view of a device in accordance with a second embodiment of the present invention.

FIG. 5 shows a flowchart illustrating a method for surface treatment of a 3D printed part in accordance with a third embodiment of the present invention.

FIG. 6 shows top-down view of an untreated surface and a surface treated in accordance with a surface treatment method of the present invention at 290× magnification.

FIG. 7 shows scanning electron microscope (SEM) images of a cross-section of surface treated small samples under five different magnifications.

### LIST OF TABLES

Table 1 shows Ra values measured during experiment 1.

Table 2 shows Ra values measured during experiment 2.

### DETAILED DESCRIPTION

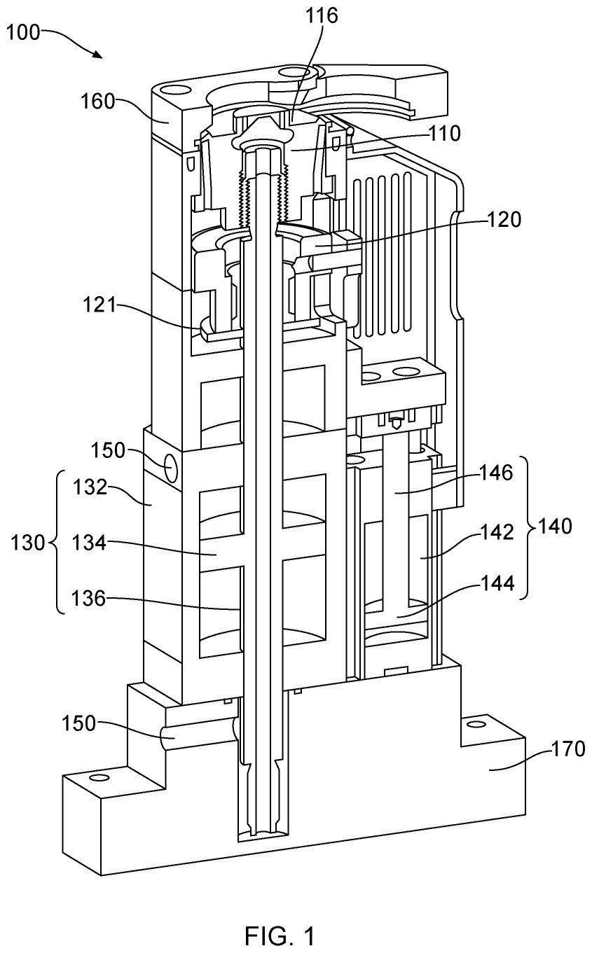

FIG. 1 shows a cross-sectional view of a device 100 for surface treatment of a 3D printed part in accordance with a first embodiment of the present invention. The device 100 comprises a resurfacing tool 110, a heating device 120, an actuator 130 and a plurality of inlet/outlet ports 150.

The resurfacing tool 110 comprises a contact surface 116, wherein the contact surface 116 comprises a negative shape of a surface to be treated of the 3D printed part. As the contact surface 116 comprises the negative shape of the surface to be treated, when the resurfacing tool 110 is pressed against said surface, the contact surface 116 of the resurfacing tool 110 slots into the corresponding positive shape of the surface and a contact is established between the contact surface 116 and the surface to be treated. In an embodiment of the invention, the surface to be treated could be, for example, a valve seat in a 3D printed valve or connecting portions of a 3D printed connector/adaptor. The contact surface 116 may also optionally be shrink compensated, depending on the material (e.g. thermo plastic) used in the 3D printed part.

The resurfacing tool 110 comprises a metal material as metals are good conductors of heat. In this embodiment, copper is used to make the resurfacing tool 110. In alternate embodiments of the invention, the resurfacing tool 110 comprises a metal material comprising one or more of: copper, iron, steel and aluminium.

The resurfacing tool 110 is configured to be releasably pressed against the surface to be treated of the 3D printed part. This is achieved by operating the actuator 130 connected to the resurfacing tool 110 to move the resurfacing tool 110 with respect to the surface to be treated.

In this embodiment, the actuator 130 comprises a cylinder 132 comprising a piston 134 connected to a piston rod 136. As shown in FIG. 1, the resurfacing tool 110 is connected to the piston 134 via the piston rod 136. In an example, the cylinder 132 is a pneumatic cylinder operable to move the resurfacing tool 110 in a linear fashion by actuating the first piston 134 within the first cylinder 132.

The resurfacing tool 110 is further connected to a heating device 120 configured to heat the resurfacing tool 110 to a temperature above the melting temperature of a material of the 3D printed part such that the surface to be treated can be melted when the resurfacing tool 110 is pressed against the surface to be treated. As the contact surface 116 of the resurfacing tool 110 is shaped to fit into the surface to be treated, a uniform transfer of heat from the resurfacing tool 110 to the surface to be treated can be achieved. This in turn helps to achieve uniform melting of the surface to be treated.

In one or more embodiments of the invention the material of the 3D printed part comprises thermoplastics material, e.g. comprising polypropylene. Preferably, a relatively dense material may be used so that pore sintering of the 3D printed part may be minimised in order to lessen shrinkage. Materials such as COC material may also be used, for example, printed using FDM-technology.

In this embodiment, the heating device 120 is in the form of an external heated metal block configured to be releasably pressed against the resurfacing tool 110. When the heated metal block is pressed against the resurfacing tool 110 heat is transferred from the heated metal block to the resurfacing tool 110. An advantage of the metal block as the heating device 120 is that as it is external to the resurfacing tool 110, melting of the surface to be treated can be stopped almost instantly by simply releasing the metal block from the resurfacing tool 110. Thus, cooling and reheating of the heating device 120 during each cycle is not required in this embodiment as the metal block can be maintained at a constant temperature. This leads to reduced cycle time resulting in faster turnaround time. In this embodiment, copper is used to make the metal block. In alternate embodiments, the metal block comprises a metal material comprising one or more of iron, steel, copper and aluminium. In alternate embodiments the heating device 120 could be internal to the resurfacing tool 110 and integrated to it.

In this embodiment, the heating device 120 is moved with respect to the resurfacing tool 110 by operating another actuator 140. As shown in FIG. 1, actuator 140 comprises a cylinder 142 comprising a piston 144 connected to a piston rod 146. In this embodiment, the cylinder 142 is a pneumatic cylinder operable to move the heating device 120 in a linear fashion by linearly moving the second piston 144 within the second cylinder 142. A bracket provided at an upper end of the actuator 140 is connected to the heating device 120.

The actuator 130 and the actuator 140 are not limited to being pneumatic cylinders and in other embodiments, could be a hydraulic cylinders or electrical actuators, etc.

The device 100 also comprises a cooling device operable to cool the resurfacing tool 110 to thereby re-solidify the molten layer produced at the surface to be treated. The cooling device comprises a coolant fluid source (e.g. containing air, water, oil, etc.) connected to the resurfacing tool 110. In an embodiment of the invention, the cooling device is operable to flow the coolant fluid through the one or more internal fluid channels 113 of the resurfacing tool 110.

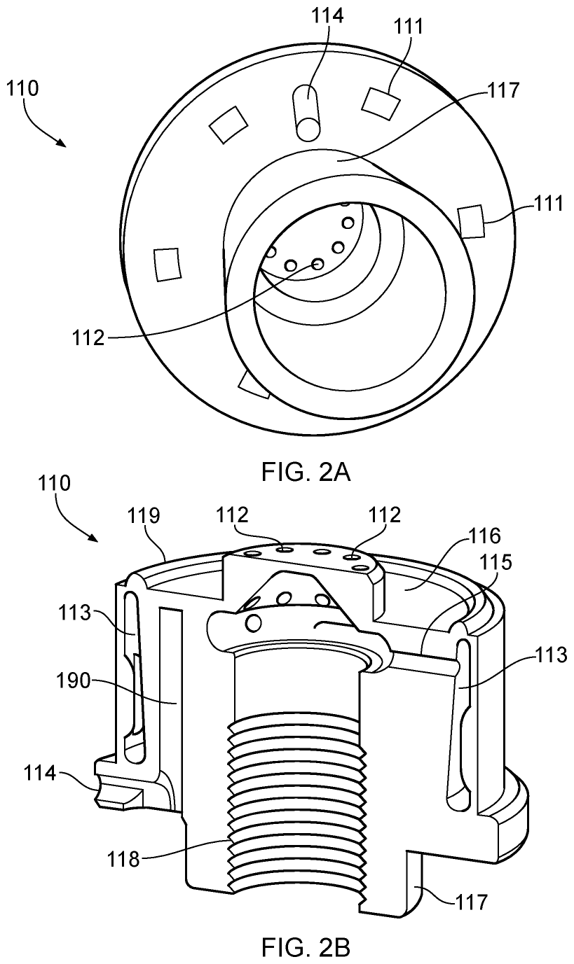

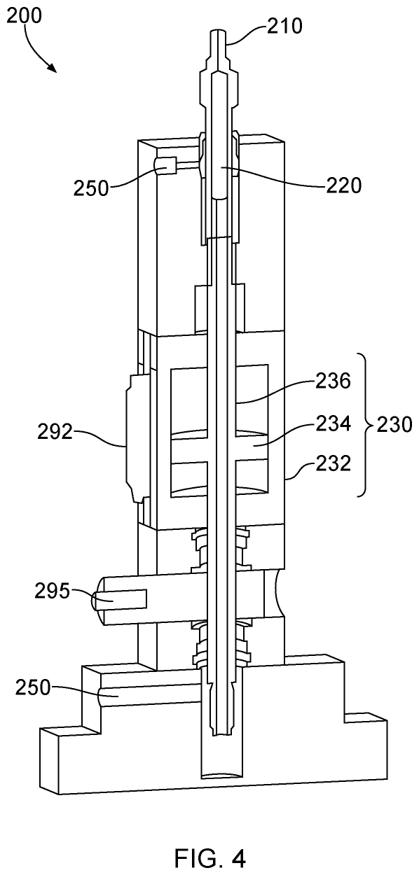

In another embodiment of the invention, the device 100 further comprises a plurality of sensors (shown in FIG. 2B and FIG. 4) configured to measure at least one process control parameter of a surface treatment method implemented within the device 100. The process control parameters comprise for example, a temperature of the resurfacing tool 110 and/or the heating device 120, a pressure exerted on the surface to be treated by the resurfacing tool 110, a position of the resurfacing tool 110 with respect to the surface to be treated, a position of the heating device 120 with respect to the resurfacing tool 110, and a thickness of the molten layer at said surface. The plurality of sensors comprises one or more of a position sensor, a temperature sensor, a pressure sensor, a depth sensor and a solidification sensor. The position sensor could be, for example, an inductive sensor or a light-based sensor. The solidification sensor could be, for example, a fibre optic refractive index sensor. Several different types of sensors are known and readily available and thus the skilled person can use any suitable sensor.

In an alternate embodiment of the invention, the device 100 further comprises a control unit configured to control the surface treatment method based on one or more measurements taken by one or more of the plurality of sensors. In an example, the control unit can be configured to control melting of the surface to be treated such that when a measurement taken by a depth sensor indicates that a maximum thickness of the molten layer has been reached, the control unit signals to deactivate the heating device 120 to stop heating the resurfacing tool 110 any further to stop the melting of said surface. In another example, the control unit can signal to activate the heating device 120 when the resurfacing tool 110 is below the melting temperature of the material of the 3D printed part.

FIG. 1 further shows an insulation device 121 coupled to the heated metal block 120. The insulation device 121 is configured to prevent loss of heat from the heated metal block 120 such that the heated metal block 120 could be efficiently maintained at a desired temperature. The insulation device 121 also protects other parts of the device 100 that do not require heating. For example, the insulation device 121 is used to help prevent the piston rod 136 from heating so that it does not transfer substantial heat energy from the heated metal block 120 to the resurfacing tool 110. Additionally, since the component tolerances in the device 100 are fairly small, the insulation device 121 also helps to avoid changes in temperature that might otherwise induce thermal expansion that may subsequently affect friction between sliding surfaces.

The device 100 further comprises a plurality of inlet/outlet ports 150. A first port 150 is used to connect the device 100 to a coolant fluid source to supply a coolant to the resurfacing tool 110 to cool the resurfacing tool 110. A second port 150 is used to connect the device 100 to a pressurized fluid source to power the actuator 130 and the actuator 140.

FIG. 2A shows a perspective view of the resurfacing tool 110 of the device 100 of FIG. 1. In this embodiment, the resurfacing tool 110 comprises a plurality of openings/vents 111 and 112. In this embodiment, the openings/vents 111 are located in an outer area of the resurfacing tool 110 and the openings/vents 112 are located in a central area of the resurfacing tool 110. The plurality of opening/vents 111 and 112 allow the coolant fluid to enter and exit the resurfacing tool 110 during the cooling of the resurfacing tool 110. In an alternate embodiment, the plurality of openings/vents 111 and 112 could be placed differently depending on the contours of a surface to be treated.

FIG. 2A also shows an elongated neck portion 117 to connect the resurfacing tool 110 to the piston rod 136 such that the resurfacing tool 110 can be linearly moved with respect to the 3D printed part being treated.

FIG. 2B shows a cross-sectional view of the resurfacing tool 110 of the device 100 of FIG. 1. In this embodiment, the plurality of openings/vents 111 and 112 open into the one or more internal fluid channels 113 within the resurfacing tool 110. In this embodiment the internal fluid channels 13 are interconnected via duct 114 and duct 115. The internal fluid channels 113 allow the coolant to be circulated within the resurfacing tool 110 to cool the resurfacing tool 110.

FIG. 2B also shows the openings/vents 111 in cross-sectional view. As shown, the openings/vents 111 are located in an outer area of the resurfacing tool 110. This positioning of the openings/vents 111 on the resurfacing tool 110 allows to rapidly circulate the coolant fluid around the periphery of the resurfacing tool 110 via the one or more internal fluid channels 113 to form a cooled barrier for the molten layer at the surface being treated. An advantage of the cooled barrier is that it prevents the melt pool from running over an outer edge 119 of the resurfacing tool 110 as the cooled barrier helps to quickly solidify the molten layer around the outer edge 119 to form a seal. Another advantage of providing the cooled barrier is that external sealing rings are not required and thus maintenance costs are reduced as replacement of external sealing rings is not needed. A further advantage is also that contact pressure does not have to be very high due to the self-forming seal of material (e.g. plastic). Similarly, the openings/vents 112 are located in a central area of the resurfacing tool 110 to provide a cooled barrier around an inner edge of the molten layer.

FIG. 2B also shows internal threads 118 on an internal surface of the elongated neck portion 117. The internal threads 118 are configured to engage with complimentary threads provided on the piston rod 136 to connect the resurfacing tool 110 to the piston 132. In alternate embodiments, a different fitting could be used to attach the resurfacing tool 110 to the piston rod 136, for example, a push-fitting, welding, a barbed-fitting, a screw-fitting, a flange-fitting or via a suitable adapter. Several such fittings are well known and can be readily used by the skilled person.

FIG. 2B also shows a cavity 190 for housing a temperature sensor within the resurfacing tool 110. The temperature sensor is configured to measure the temperature of the resurfacing tool 110 and may be placed into the cavity 190 with a heat transferring paste in order to ensure that quick temperature readings are possible. In an embodiment of the invention, the temperature measurement is relayed to the control unit which then signals actuation of the piston 132 to position the resurfacing tool 110 in accordance with the surface treatment method being implemented in the device 100.

FIG. 2B also shows the contact surface 116 of the resurfacing tool 110. As explained previously the contact surface 116 comprises a negative shape of the surface to be treated. The resurfacing tool 110 is machined to the exact dimensions of the surface to be treated and the contact surface 116 is processed to have a high surface finish. High surface finish of the contact surface 116 is required as the surface finish of the contact surface 116 gets transferred to the surface to be treated when the resurfacing tool 110 is pressed against the surface to be treated. Thus, the surface finish of the contact surface 116 has a direct impact on the overall surface finish of the treated surface. Thus, choice of the material of the resurfacing tool 110 is an important factor in achieving a desired surface finish on the surface to be treated as the material used would affect the smoothness of the resurfacing tool 110. In one or more embodiments of the invention, the mean surface roughness Ra value of at least part of the contact surface 116 of the resurfacing tool is preferably less than about 2 to about 2.4 μm. For example, a mean Ra value may be less than 1 μm, such as in the range of about 0.7-0.9 μm.

In this embodiment of the invention, the resurfacing tool 110 is made from copper material. Using a metal material is advantageous as metals in general are good conductors of heat and electric current. Also, as metals are malleable and ductile, it is possible to machine them to exact dimensions of the surface. For similar reasons it is also possible to produce high gloss surfaces on metal parts. These features of metal material are thus advantageous for making the resurfacing tool 110. In alternate embodiments of the present invention, other metals can be used, for example, one or more of iron, aluminium and steel or an alloy comprising copper. In another embodiment, the resurfacing tool 110 could additionally be coated to get an inert surface that does not negatively affect the material of the 3D printed part.

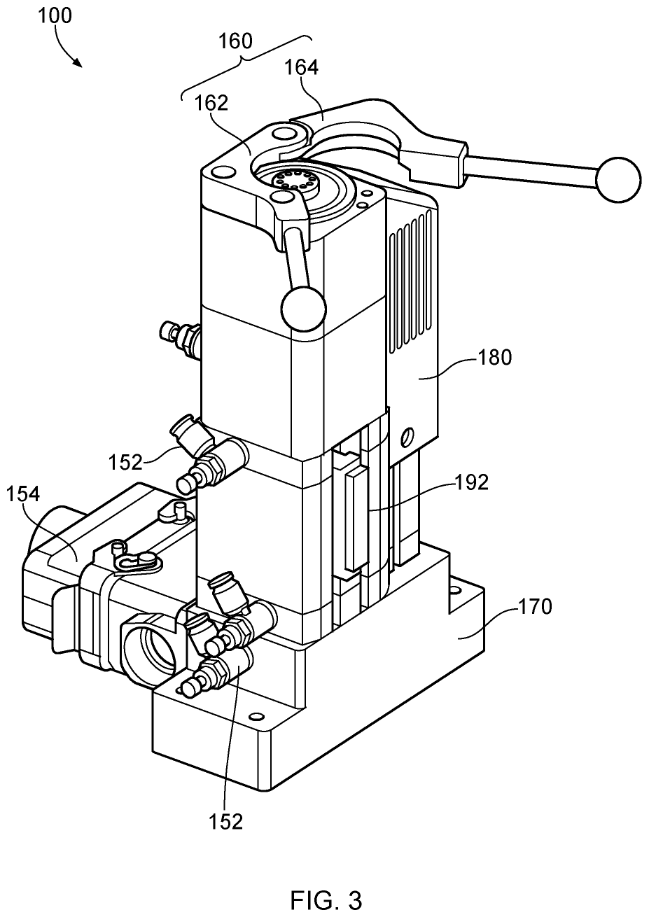

FIG. 3 shows a perspective view of the device 100 of FIG. 1. In this embodiment, the device 100 comprises a securing device 160 located near a top portion of the device 100. The securing device 160 is operable to secure a 3D printed part to the device 100 during a surface treatment method. In this embodiment, the securing device 160 is a flange type lever lock comprising a fixed flange portion 162 connected to a movable flange portion 164. The flange portions 162 and 164 are operable to open and close the securing device 160 as needed via handles attached to said flange portions. FIG. 3 shows the securing device 160 as open and ready to receive the 3D printed part for surface treatment in the device 100. In other embodiments of the invention, a different type of securing device 160 could be used, for example, a clamp. Further, the securing device 160 could be configured for manual or automatic operation.

FIG. 3 also shows a position sensor 192 for measuring position of the piston 134 within the cylinder 132. As the resurfacing tool 110 is connected to the piston 134, a measurement taken by the position sensor 192 can be correlated to a position of the resurfacing tool 110 with respect to the surface to be treated. In an embodiment of the invention, the control unit can be configured to control the surface treatment method by controlling the movement of the piston 134 within the cylinder 132. For example, the control unit can be configured to turn on a red indicator light on the position sensor 192, when a first measurement taken by the position sensor 192 co-relates to a first position of the resurfacing tool 110 where it is pressed against the surface to be treated and the melting has started.

In another example, the control unit can be configured to turn on a green indicator light on the position sensor 192, when a second measurement taken by the position sensor 192 co-relates to a second position of the resurfacing tool 110 where it has been retracted and thus it is safe to remove the 3D printed part from the device 100.

In this embodiment, the position sensor 192 is an inductive sensor, but other types of position sensors could be readily used by the skilled person, for example, a light-based sensor.

FIG. 3 also shows a plurality of fluid control valves 152 attached to the plurality of inlet/outlet ports 150. A first fluid control valve 152 is configured to control flow of a coolant fluid to the one or more internal fluid channels 113 of the resurfacing tool 110 to cool the resurfacing tool 110. A second fluid control valve 152 is configured to control flow of a pressurized fluid to actuate the piston 134 and the piston 144.

FIG. 3 also shows a safety cover 180 to cover any moving parts of the device 100 to ensure safety during use. Also shown in FIG. 3 is a base portion 170 to facilitate mounting the device 100 to a work bench using any suitable fastening device such as screws. Further, a connector 154 is shown attached near the base of the device 100. In an embodiment of the invention, the connector 154 is used to connect the device 100 to a control unit to control the heat treatment method being implemented in the device 100.

In another embodiment of the invention, a device in accordance with the invention comprises a vacuum unit to minimize the risk of entrapment of gas bubbles damaging the surface to be treated during melting.

FIG. 4 shows a cross-sectional view of a device 200 in accordance with a second embodiment of the present invention. The device 200 comprises a resurfacing tool 210, a heating device 220 and a locking device 295. In this embodiment, the heating device 220 is integral to the resurfacing tool 210. In an example, the heating device 220 is an induction coil powered by electric current. An advantage of this configuration is that the device 200 is more compact and lighter as compared to the device 100 because the metal block and the actuator to move the metal block are eliminated. This configuration is particularly useful when the surface to be treated has a smaller surface area as then the resurfacing tool 210 would be small too. The time taken to heat and cool a smaller resurfacing tool 210 would thus be much less and thus repeated heating and cooling would not make a big difference in the cycle time and thus the overall build time.

The actuator 230 is operable to move the resurfacing tool 210 to releasably press against a surface to be treated of a 3D printed part. As shown in FIG. 4, the actuator 230 comprises a cylinder 232 comprising a piston 234 connected to the piston rod 236. In this embodiment, the cylinder 232 is equipped with a locking device 295 operable to lock the piston 234 in position to provide additional control over the surface treatment method.

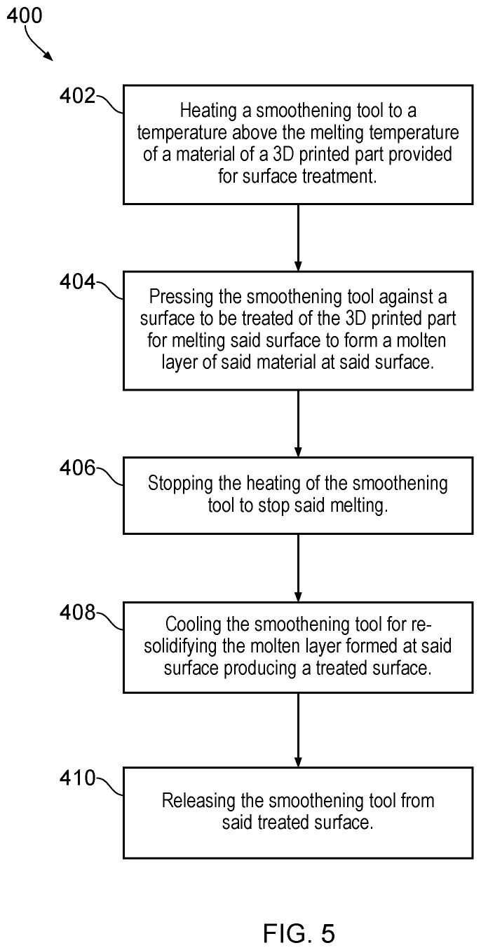

FIG. 5 shows a flowchart illustrating a method 400 for surface treatment of a 3D printed part in accordance with a third embodiment of the invention. The method 400 is generally applicable for 3D printed parts comprising thermoplastics material. Thus, only the process parameters would differ based on the specific thermoplastic polymer of which the 3D printed part is made.

The method 400 can be used to provide localised treatment at a portion of a 3D printed part without causing sharp interface lines to occur at positions where the resurfacing tool ends. To achieve this, outermost edges of the heating tool may be cooled (e.g. either actively, or passively to provide a non-linear temperature profile or step). Hence, when molten material is in contact with the heating tool, it will then flow in a central contact area and will subsequently solidify as it reaches the cooled or relatively cooler edge(s) of the resurfacing tool. This also enables the resurfacing tool to provide a self-sealing action without requiring the use of the extreme pressures usually needed for reshaping methods like injection and certain other types of moulding.

As shown, the method 400 comprises a heating step 402, a pressing step 404, a stopping step 406, a cooling step 408 and a releasing step 410.

The heating step 402 comprises heating a resurfacing tool (which may also be referred to as a smoothening tool) to a temperature above the melting temperature of a material of a 3D printed part provided for surface treatment. This is achieved by activating a heating device connected to the resurfacing tool. In an embodiment of the invention, the heating step 402 comprises activating the heating device by linearly moving the heating device for pressing against the resurfacing tool. In another embodiment, the heating step 402 comprises activating the heating device by switching on a heating element embedded in the resurfacing tool.

The temperature to which the resurfacing tool is heated depends on a material of the 3D printed part being treated. Thus, for example, if the material is polypropylene (PP), the resurfacing tool could be heated to a temperature in the range of about 160° C.-166° C.

In another example, where the material is a PP adapted for 3D-printing, e.g. comprising a PP mixed with PE that has a melting temperature of about 125° C., the resurfacing tool may be heated to about 240° C. This is done so as to quickly melt the outermost surface to a very low viscous state for the plastic to flow easily. It is then cooled quickly in order to leave as much of the 3D printed part as possible unaffected by the heat in order to avoid distortion and shrinkage.

The pressing step 404 comprises pressing the resurfacing tool against the surface to be treated of the 3D printed part for melting said surface to form a molten layer of said material at said surface. This is achieved by operating an actuator connected to the resurfacing tool to move the resurfacing tool to a first position with respect to the surface to be treated. As the material of the 3D printed part melts at the surface, the molten material due to its low viscosity flows on said surface filling up the gaps and voids therein thus levelling them off.

The stopping step 406 comprises stopping the heating of the resurfacing tool to stop the melting of said material. This is achieved by deactivating the heating device connected to the resurfacing tool. In an embodiment of the invention, the stopping step 406 is performed such that the thickness of the molten layer formed at said surface is relatively shallow such that the main body of the 3D printed part is largely unaffected by the heat treatment. For example, a final consolidated cooled layer formed may be to a depth of about 5, 10, 15, 20, 30, 40 or 50 μm etc. within the treated 3D printed part. In an embodiment of the invention, the heating device is deactivated by linearly moving the heating device for releasing the heating device from the resurfacing tool. In another embodiment, the heating device is deactivated by switching off a heating element integral to the resurfacing tool.

The cooling step 408 comprises cooling the resurfacing tool for re-solidifying the molten layer formed at said surface for producing a treated surface. The cooling is achieved by connecting a source of coolant fluid to the resurfacing tool. In an embodiment of the invention, the coolant fluid is flowed through one or more internal fluid channels within the resurfacing tool. This prevents the molten material from evacuating the treatment area because the molten material solidifies as it reaches the cooled barriers at the edges. This creates a seal which is advantageous as this eliminates the use of a specifically designed edge seal which would leave a mark in the finished detail.

The releasing step 410 comprises releasing the resurfacing tool from said treated surface. This is achieved by actuating the piston connected to the resurfacing tool to move the resurfacing tool to a second position with respect to the surface to be treated.

The below experiments were conducted to compare the improvement in surface finish between untreated surfaces and surfaces treated using the method and apparatus of the present invention. The below experiments were also conducted to compare the surface finish obtained by using the method and apparatus of the present invention with a known method of tumbling.

### Experiment 1

A 3D printed polypropylene connector of a first type was used for this experiment as specimen 1. Specimen 1 was subjected to the surface treatment method 400 of the present invention at its top and bottom surfaces to improve the surface finish of said surfaces. Surface roughness of specimen 1 was measured using a confocal microscope as Ra values at both the top and the bottom surfaces, before and after subjecting the specimen 1 to the surface treatment process 400. The Ra values as measured are provided in Table 1 below, in units of μm. Ra values were measured at four different positions on the top surface and averaged to get an average Ra value for the top surface. Similarly, Ra values were measured at four different positions on the bottom surface and averaged to get an average Ra value for the bottom surface.

TABLE 1
Specimen 1

| | | Ra value before | Ra value after |
|---|---|---|---|
| | Position | Surface Treatment | Surface Treatment |
| Top | 1 | 20.172 | 0.839 |
| | 2 | 11.972 | 0.801 |
| | 3 | 16.296 | 1.239 |
| | 4 | 15.42 | 3.977 |
| Average | | 15.97 | 1.714 |
| Bottom | 1 | 15.537 | 1.069 |
| | 2 | 24.298 | 0.95 |
| | 3 | 18.569 | 0.919 |
| | 4 | 23.493 | 1.396 |
| Average | | 20.47 | 1.0835 |

A comparison of Ra values measured before and after the surface treatment process show a significant decrease in the Ra values as a result of the surface treatment. As can be seen in Table 1, for the top surface of Specimen 1, the average/mean Ra value before treatment was 15.97 which was reduced to an average Ra value of 1.714 post surface treatment representing an 89.27% reduction in the average Ra value after surface treatment. Similarly for the bottom surface, the average Ra value before treatment was 20.47 which was reduced to an average Ra value of 1.0835 post surface treatment representing a 94.71% reduction in the average Ra value after surface treatment.

### Experiment 2

Two identical 3D printed polypropylene connectors of a second type were used for this experiment as specimen 2. In this experiment a first specimen 2 was subjected to a known post-processing process of tumbling and a second specimen 2 was subjected to the surface treatment method 400 of the present invention. Ra values of the first specimen 2 were measured after subjecting the first specimen 2 to the tumbling process at a first side and a second side of the first specimen 2. Similarly, Ra values of the second specimen 2 were measured after subjecting the second specimen 2 to the surface treatment process of the invention at a first side and a second side of the second specimen 2. The Ra values as measured by confocal microscopy for the first and the second specimen 2 are provided in Table 2 below. Ra values for the first specimen 2 were measured at four different positions on each of its first and second sides and averaged to get an average Ra value corresponding to said first and second sides of the first specimen 2. Ra values were similarly measured and averaged for the second specimen 2.

TABLE 2

| | | | Second Specimen 2 |
|---|---|---|---|
| | | | Ra value after surface |
| | | First Specimen 2 | treatment (using |
| | | Ra value after | process of the |
| | Position | Tumbling | invention) |
| First side | 1 | 4.598 | 0.796 |
| | 2 | 3.81 | 0.721 |
| | 3 | 3.847 | 0.85 |
| | 4 | 4.803 | 0.725 |
| Average | | 4.2645 | 0.773 |
| Second side | 1 | 2.414 | 0.793 |
| | 2 | 3.943 | 0.656 |
| | 3 | — | 0.946 |
| | 4 | — | 1.067 |
| Average | | 3.1785 | 0.8655 |

A comparison of Ra values measured for the second specimen 2 showed much lower values compared to Ra values measured for the first specimen 2 indicating that the surface treatment method 400 of the present invention provides better surface finish as compared to the known tumbling process.

As shown by the above experiments, the method 400 of the present invention was able to bring the mean surface roughness Ra value down to a range of 0.773 to 1.714 in the treated surface.

With conventional tumbling it is generally possible to obtain mean treated surface Ra values of about 4 μm. However, for any internal surfaces of a 3D printed part, obtaining such values is difficult since the internal surfaces are not easily accessible and so the surface finish will vary close to the internal surface and proximal to any external edges/corners. Narrow channels provided in such a part are also difficult to treat using this type of post-processing technique.

Hence, a tumbled 3D printed part, such as a 3D printed part for bioprocessing equipment having a valve seat formed in an internal channel thereof for example, may not finally even obtain a mean Ra value of 4 μm at certain system-critical portions thereof. For example, an Ra value closer to the untumbled/raw Ra values of Experiment 1 above (e.g. greater than a mean of about 16 μm) may still be present at a valve seat position therein.

Ra values may be determined by using a confocal laser microscope to image a small section of the surface. Taking a line section across the image provides an Ra profile for this specific section of the surface in a specific orientation. Various other techniques for characterising a surface based on measuring a roughness parameter, or the like, may also be used as appropriate.

Other techniques (e.g. of the non-optical, contact type) may also be used to measure Ra. For example, by using a very sensitive needle which is dragged over a specified length of the surface. However, these techniques may not be preferred when dealing with 3D printed plastic materials as they may effectively scribe a line in the plastic, thus resulting in Ra measurements that appear smoother than reality.

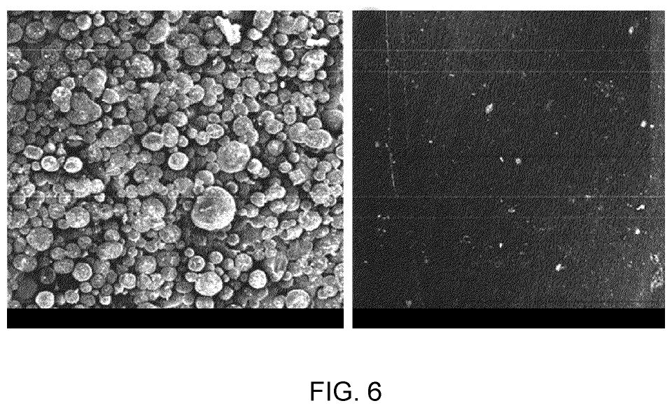

FIG. 6 shows top-down views of a non-treated and a surface treated in accordance with a surface treatment method of the present invention at 290× magnification. Image c) shows a non-treated surface having a grainy surface topology where pores and crevices are visible. Image b) shows a surface subjected to a surface treatment method of the present invention where the surface topography looks non-grainy and smooth as the pores and crevices are filled by melting and resolidifying of the surface.

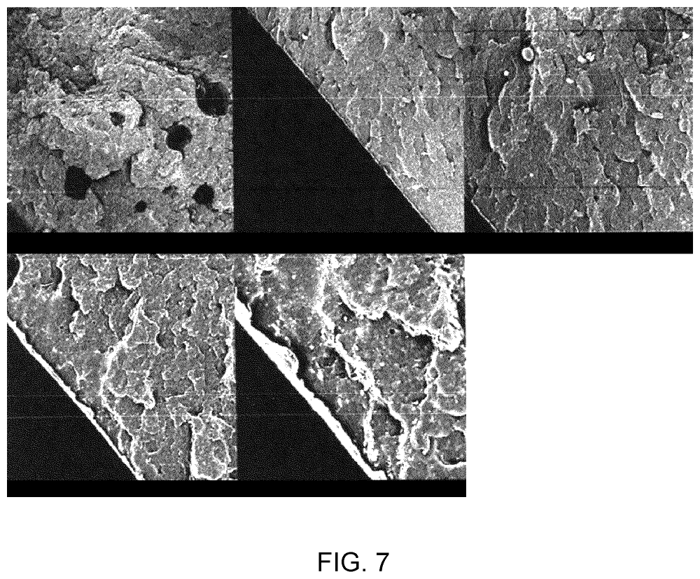

FIG. 7 shows scanning electron microscope (SEM) images of the cross-section of heat-treated small samples with magnification a) 200×BSD, b) 230×BSD, c) 280×BSD, d) 850× BSD, e) 2250×BSD. Samples of a surface treated in accordance with a method of the present invention were cryo-fractured and studied using SEM imaging. Cryo-fracturing was used to avoid use of tooling that could otherwise make the affected layers appear thicker than they actually are. As show in FIG. 7, the melting at the surface is quite localised with about 10 μm thickness. The rest of the material is thus not affected by the surface treatment method of the invention.

Various aspects and embodiments of the present invention have been described herein. However, the present invention is not to be seen as being limited by the embodiments described above, but can be varied within the scope of the appended claims as will be readily apparent to the person skilled in the art.

Bioprocessing equipment could be but not limited to, for example, a chromatography system, a filtration system, an aseptic filling system, a fermentation system, a bioreactor assembly or a mixer assembly. In one or more embodiments of the invention, the device is operable manually or is semi-automated or full automated. Source of coolant fluid could be for example, a source of cooled air or gas or a cooled liquid. The device of the invention could be used as a standalone device or be part of an assembly line. In one or more embodiments of the invention, the method for surface treatment could be performed manually, semi-automatically or fully automatically. The method of the invention could be performed using a PLC based control unit by using one or more closed feedback loops to control the various process parameters. The method of the invention could also be performed using an open loop configuration. The device of the invention can be used to treat a variety of 3D printed parts by adapting the resurfacing tool to the shape of the surface to be treated. The control unit may be a computing device, a semiconductor-based microprocessor, a central processing unit (CPU), an application specific integrated circuit (ASIC), and/or other hardware processing device. The controller may be a separate component or may be integrated with the device.

1. A device (100, 200) for surface treatment of 3D printed parts for bioprocessing equipment, comprising:
a resurfacing tool (110, 210) comprising a contact surface (116), wherein the contact surface (116) comprises a negative shape of a surface to be treated of a 3D printed part;
a heating device (120, 220) operable to heat the resurfacing tool (110, 210) to a temperature above the melting temperature of a material of the 3D printed part;
an actuator (130, 230) operable to move the resurfacing tool (110, 210) such that the resurfacing tool (110, 210) can be releasably pressed against the surface to be treated to melt said surface to form a molten layer of said material at said surface; and
a cooling device operable to cool the resurfacing tool (110, 210) to thereby re-solidify the molten layer of said material at said surface to form a treated surface.

2. The device (100, 200) of claim 1, wherein the heating device (120, 220) comprises:
an external heated metal block (120) configured to be releasably pressed against the resurfacing tool (110); or
a heating element (220) integral to the resurfacing tool (210).

3. The device (100, 200) of claim 1 or claim 2, wherein the actuator (130, 230) is operable to move the resurfacing tool (110, 210) substantially linearly.

4. The device (100, 200) of any of the preceding claims, wherein the actuator (130, 230) comprises a cylinder (132, 232) comprising a piston (134, 234), wherein the piston (134, 234) is connected to the resurfacing tool (110, 210).

5. The device (200) of claim 4, further comprising a locking device (295) operable to lock the piston (234) in position within the cylinder (232).

6. The device (100, 200) of any of the preceding claims, further comprising:
a plurality of sensors (190, 192, 292) configured to measure at least one process parameter of a surface treatment method (400) being implemented in the device (100, 200); and
a control unit configured to control the surface treatment method (400) based on one or more measurements taken by one or more of the plurality of sensors (190, 192, 292).

7. The device (100, 200) of claim 6, wherein the plurality of sensors (190, 192, 292) comprises one or more of: a position sensor (192, 292), a temperature sensor (190), a pressure sensor, a depth sensor and a solidification sensor.

8. The device (100, 200) of any of the preceding claims, wherein the cooling device comprises a coolant fluid source connected to the resurfacing tool (110, 210).

9. The device (100, 200) of any of the preceding claims, wherein the resurfacing tool (110, 210) comprises one or more internal fluid channels (113).

10. The device (100, 200) of any of the preceding claims, wherein a material of the resurfacing tool (110, 210) comprises a metal material comprising one or more of: copper, iron, steel and aluminium.

11. The device (100, 200) of any of the preceding claims, wherein at least part of the contact surface (116) of the resurfacing tool (110, 210) has a low value mean surface roughness value Ra (m) that is: less than about 16 μm; less than about 15, 14, 13, 12, 11, 10, 9, 8, 7, 6, 5, 4, 3, 2.4, 2, 1.6, 1.5 or 1 μm; about 0.5 μm; from about 0.4, 0.5 or 0.6 μm to about 0.7, 0.8 or 0.9 μm; from about 0.7 to about 0.8 or 0.9 μm; and/or in the range from about 0.1, 0.2, 0.3, 0.4, 0.5, 0.6, 0.7, 0.8 or 0.9 μm to about 15, 14, 13, 12, 11, 10, 9, 8, 7, 6, 5, 4, 3, 2.4, 2, 1.6, 1.5 or 1 μm.

12. The device (100, 200) of any of the preceding claims, further comprising a securing device (160) operable to secure the 3D printed part to the device (100, 200) during the surface treatment process (400).

13. The device (100, 200) of any of the preceding claims, wherein the resurfacing tool (110, 210) is configured to engage a valve seat portion of the 3D printed part.

14. A method (400) for surface treatment of 3D printed parts for bioprocessing equipment, comprising:
heating (402) a resurfacing tool to a temperature above the melting temperature of a material of a 3D printed part provided for surface treatment;
pressing (404) the resurfacing tool against a surface to be treated of the 3D printed part for melting said surface to form a molten layer of said material at said surface;
stopping (406) the heating (402) of the resurfacing tool to stop said melting;
cooling (408) the resurfacing tool for re-solidifying the molten layer formed at said surface producing a treated surface; and
releasing (410) the resurfacing tool from said treated surface.

15. The method (400) of claim 14, wherein the thickness of the molten layer at said surface is in the range of less than about 10, 15, 20, 30, 40 or 50 μm, 0.1-10.0 μm, in the range of about 4.0-9.0 μm and/or in the range of about 6.0-8.0 μm.

16. The method (400) of claim 14 or claim 15, wherein the heating step (402) comprises heating the resurfacing tool to a temperature at least about: 10%, 20%, 30%, 40%, 50%, 60%, 70%, 80%, 90% or 100%, or from about 10%, 20%, 30%, 40%, 50% to about 70%, 80%, 90%, or 100% to about 150%, above a melting point temperature (MP) of the material of the 3D printed part, for example to about 240° C. where the material is a PP mixed with PE having a melting temperature of about 125° C.

17. The method (400) of any of claims 14-16, wherein the heating step (402) and the stopping step (406) comprises activating and deactivating a heating device connected to the resurfacing tool respectively.

18. The method (400) of any of the claims 14-17, wherein the cooling step (408) comprises flowing a coolant fluid through one or more internal fluid channels of the resurfacing tool.

19. The method (400) of any of the claims 14-18, wherein the pressing step (404) and the releasing step (410) comprises actuating a piston within a cylinder for moving the resurfacing tool to a first position and a second position respectively with respect to the surface to be treated.

20. The method (400) of any of the claims 14-19, wherein the pressing step (404) comprises placing a contact surface of the resurfacing tool in contact with the surface to be treated.

21. A 3D printed part for bioprocessing equipment, comprising at least a partial surface portion thereof having a mean surface roughness value Ra (m) that is: less than about 16 μm; less than about 15, 14, 13, 12, 11, 10, 9, 8, 7, 6, 5, 4, 3, 2.4, 2, 1.6, 1.5 or 1 μm; about 0.5 μm; from about 0.4, 0.5 or 0.6 μm to about 0.7, 0.8 or 0.9 μm; from about 0.7 to about 0.8 or 0.9 μm; and/or in the range from about 0.1, 0.2, 0.3, 0.4, 0.5, 0.6, 0.7, 0.8 or 0.9 μm to about 15, 14, 13, 12, 11, 10, 9, 8, 7, 6, 5, 4, 3, 2.4, 2, 1.6, 1.5 or 1 μm.

22. The 3D printed part of claim 21, wherein the at least partial surface portion comprises a valve seat, an internal surface and/or a connecting portion of a connector/adaptor.

23. The 3D printed part of claim 21 or claim 22, wherein a material of said part comprises one or more of: thermoplastics material, polypropylene (PP), polyethylene (PE) and/or cyclic olefin copolymer (COC) polymer.

24. The 3D printed part of any of claims 21 to 23, comprising a surface treated layer having a depth in the range of less than about 10, 15, 20, 30, 40 or 50 μm, from about 0.1-10.0 μm, in the range of about 4.0-9.0 μm and/or in the range of about 6.0-8.0 μm.
